(19) United States
(12) Patent Application Publication
(10) Pub. No.: US 2016/0160753 A1
(43) Pub. Date: Jun. 9, 2016

(54) Auxiliary Fuel Tank For A Portable Generator

(71) Applicant: Generac Power Systems, Inc., Waukesha, WI (US)

(72) Inventors: Jonathon Boutot, Waukesha, WI (US); Nicolas Saeger, Corner, GA (US); Casey Daugherty, Milwaukee, WI (US); Margaret Whitney Montondo, Waukesha, WI (US); Kevin Cole, Janesville, WI (US); Joel Soto, Maywood, IL (US); Chris Turner, Trempealeau, WI (US)

(21) Appl. No.: 14/963,484

(22) Filed: Dec. 9, 2015

Related U.S. Application Data
(60) Provisional application No. 62/089,684, filed on Dec. 9, 2014.

(51) Int. Cl. F02B 63/04

(52) U.S. Cl. CPC F02B 63/048

(57) ABSTRACT

A portable generator system is disclosed which includes a portable generator and an auxiliary fuel tank. The auxiliary fuel tank may be mounted to and removed from the portable generator without tools. A fuel connector between the auxiliary fuel tank and the portable generator includes a male fitting and a female fitting. The male fitting engages the female fitting without tools and aids in aligning the auxiliary fuel tank with the portable generator.

### CROSS-REFERENCE TO RELATED APPLICATIONS

This application claims priority from U.S. Provisional Patent Application Ser. No. 62/089,684 filed on Dec. 9, 2014, the entirety of which is expressly incorporated by reference herein.

### FIELD OF THE INVENTION

This invention relates generally to portable electrical generators, and in particular, to an auxiliary fuel tank for use with a portable electrical generator.

### BACKGROUND AND SUMMARY OF THE INVENTION

Portable generators are becoming increasingly popular for providing power at remote locations. However, in order to transport the portable generator to the remote location, the size of the portable generator must be kept small enough to be carried and/or manually lifted into and out of a vehicle. Further, the weight of fuel can significantly add to the weight of a portable generator. As a result, the fuel capacity of portable generators is typically limited to maintain the desired portability. The limited fuel capacity results in a limited run time of the portable generator.

Thus, it would be desirable to provide an auxiliary fuel tank that may be connected to the portable generator to extend its run time.

According to one embodiment of the invention, a fuel storage system for a fuel-powered machine is disclosed. The fuel storage system includes a housing integrally mounted to the fuel-powered machine where the housing including a first opening. A first fuel tank is mounted to the housing and is in fluid communication with the fuel-powered machine. A first portion of a fuel fitting is accessible through the first opening, and t least one auxiliary tank is removably mounted to the housing. The auxiliary tank includes a housing having a second opening and a second portion of the fuel fitting accessible through the second opening. When the auxiliary tank is mounted to the fuel-powered machine, the second portion of the fuel fitting operatively engages the first portion of the fuel fitting to establish a fluid flow path between the auxiliary tank and the first fuel tank. The fuel-powered machine may be a portable generator.

According to another aspect of the invention, the fuel-powered machine may include a control circuit, the housing integrally mounted to the fuel-powered machine includes a third opening, and the housing on the auxiliary tank includes a fourth opening. A first portion of an electrical connector may be accessible through the third opening, and a second portion of the electrical connector may be accessible through the fourth opening. At least one sensor may be mounted in the auxiliary tank. When the auxiliary tank is mounted to the fuel-powered machine, the second portion of the electrical connector operatively engages the first portion of the electrical connector to establish an electrical connection between the at least one sensor and the control circuit.

Thus, it is an object of the present invention to provide an electrical connection between the auxiliary fuel tank and the control circuit of the fuel-powered machine such that the control circuit may receive signals corresponding to an operating status of the auxiliary fuel tank.

According to another aspect of the invention, the fuel-powered machine includes a plurality of feet for supporting the fuel-powered machine. An upper surface of the housing for the auxiliary tank includes a plurality of cavities, where each cavity is operable to receive one of the feet when the auxiliary tank is mounted to the fuel-powered machine.

Thus, it is an object of the present invention that the fuel-powered machine may be stacked on the auxiliary tank.

According to another aspect of the invention, the fuel fitting is a quick-release fitting. The first portion of the fuel fitting may include a first spring biasing a piston in the first portion of the fuel fitting to a closed position, and the second portion of the fuel fitting may include a second spring biasing a plunger in the second portion of the fuel fitting to a closed position. When the fuel-powered machine is placed on the auxiliary fuel tank, the plunger engages the piston and the weight of the fuel-powered machine causes each of the first spring and the second spring to become compressed such that the both the piston and the plunger are moved to an open position establishing, at least in part, the fluid flow path between the auxiliary tank and the first fuel tank. The first fuel tank may also include a passage providing a fluid flow path to ambient air when the auxiliary tank is not mounted to the first fuel tank. When the auxiliary tank is mounted to the first fuel tank, the fuel fitting blocks the passage providing a fluid flow path to ambient air. The auxiliary tank is vented to the ambient air such that when the auxiliary tank is mounted to the first fuel tank and fuel is consumed from the first fuel tank by the fuel-powered machine, a vacuum is established between the first fuel tank and the auxiliary fuel tank to draw fuel from the auxiliary fuel tank into the first fuel tank.

Thus, it is another aspect of the invention, that the weight of the fuel-powered machine is sufficient to engage the first and second portions of the fuel fitting, providing a tool-less connection between the auxiliary fuel tank and the fuel-powered machine.

According to still another aspect of the invention, the fuel storage system may include a pump mounted within the housing, the pump including an inlet and an outlet, wherein the inlet is in fluid communication with the second portion of the fuel fitting to receive fuel from the auxiliary tank and the outlet is in fluid communication with the first fuel tank to deliver fuel from the pump to the first fuel tank.

According to another embodiment of the invention, the housing on the auxiliary tank includes a first surface and a second surface opposite the first surface. The second opening is located in the first surface, and the housing includes a third opening in the second surface. The auxiliary tank also includes a first portion of the fuel fitting accessible through the third opening, such that a first auxiliary tank may be mounted to the housing integrally mounted to the fuel-powered machine and a second auxiliary tank may be mounted to the housing of the first auxiliary tank. When the second auxiliary tank is mounted to the first auxiliary tank, the second portion of the fuel fitting in the second auxiliary tank operatively engages the first portion of the fuel fitting in the first auxiliary tank to establish a fluid flow path between the second auxiliary tank and the first auxiliary tank.

Thus, it is another object of the present invention that multiple auxiliary tanks may be utilized with one fuel-powered machine to further increase the run-time of the fuel-powered machine.

According to yet another embodiment of the invention, a modular fuel storage system for an engine is disclosed. The modular fuel storage system includes a main fuel tank and an auxiliary fuel tank. The main fuel tank includes a first cavity operable to contain fuel, a first fill opening in fluid communication with the first cavity, a fill cap removably mounted to the first fill opening, a first passage establishing a fluid flow path between the first cavity and the engine, a second passage in fluid communication with ambient air, and a first portion of a quick-release fuel fitting in fluid communication with the first cavity. The auxiliary fuel tank is removably mounted to the main fuel tank and includes a second cavity operable to contain fuel, a second fill opening in fluid communication with the second cavity, a fill cap removably mounted to the second fill opening, and a second portion of the quick-release fuel fitting. When the auxiliary fuel tank is mounted to the main fuel tank, the first and second portions of the quick-release fuel fitting establish a fuel flow path between the auxiliary fuel tank and the main fuel tank.

According to another aspect of the invention, the first portion of the fuel fitting may be located remotely from the first cavity and the first portion of the quick-release fuel fitting includes a first hose fitting and a second hose fitting. The first hose fitting receives a fuel line connected between the first cavity and the first hose fitting, and the second hose fitting is in fluid communication with ambient air. The first portion of the quick-release fuel fitting establishes a fluid flow path between the first hose fitting and the second hose fitting to ambient air when the auxiliary fuel tank is not mounted to the main fuel tank, and the first portion of the quick-release fuel fitting establishes a fluid flow path between the first hose fitting and the second portion of the quick-release, fuel fitting when the auxiliary fuel tank is mounted to the main fuel tank. Alternately, the fuel storage system may include a fuel pump having an inlet and an outlet. A first fuel line may be connected between the first portion of the quick-release fuel fitting and the inlet of the pump, and a second fuel line may be connected between the outlet and the first cavity of the main fuel tank.

According to still another embodiment of the invention, an auxiliary fuel tank for use in a fuel storage system is disclosed. The auxiliary fuel tank includes a housing having an upper surface and a lower surface opposite the upper surface. The upper surface includes multiple cavities and each of the cavities is configured to receive a foot from a fuel-powered machine placed on the upper surface. A first portion of a fuel fitting is mounted in the upper surface of the housing. The first portion of the fuel fitting is operable to engage a second portion of the fuel fitting mounted in a lower surface of the fuel-powered machine placed on the upper surface. A cavity is located within the housing and is operable to receive fuel via a fill opening. A vent is operative to selectively establish an air flow path between ambient air and the cavity. When the fuel-powered machine is placed on the upper surface of the auxiliary fuel tank, the first portion of the fuel fitting operatively engages the second portion of the fuel fitting to establish a fluid flow path between the auxiliary tank and the fuel-powered machine.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a left elevation view of a portable generator and an auxiliary fuel tank according to one embodiment of the invention wherein the portable generator is undocked from the auxiliary fuel tank;

FIG. 2 is a left elevation view of the portable generator and the auxiliary fuel tank of FIG. 1 wherein the portable generator is docked with the auxiliary fuel tank;

FIG. 3 is a top plan view of the auxiliary fuel tank of FIG. 1;

FIG. 4 is a front elevation view of the auxiliary fuel tank of FIG. 1:

FIG. 5 is a back elevation view of the auxiliary fuel tank of FIG. 1;

FIG. 6 is a left elevation view of the auxiliary fuel tank of FIG. 1;

FIG. 7 is a right elevation view of the auxiliary fuel tank of FIG. 1;

FIG. 8 is a bottom plan view of the auxiliary fuel tank of FIG. 1;

FIG. 9 is a bottom plan view of the portable generator of FIG. 1;

FIG. 10 is a side and top view of a male fitting for a fuel connector used to connect the auxiliary fuel tank to the portable generator of FIG. 1;

FIG. 11 is a top plan view of the male fitting for the fuel connector of FIG. 10;

FIG. 12 is a side elevation view of the male fitting for the fuel connector of FIG. 10:

FIG. 13 is a bottom plan view of the male fitting for the fuel connector of FIG. 10;

FIG. 14 is a sectional view of the male fitting for the fuel connector of FIG. 10;

FIG. 15 is an exploded side view of the male fitting for the fuel connector of FIG. 10;

FIG. 16 is a top and side view of a female fitting for the fuel connector used to connect the auxiliary fuel tank to the portable generator of FIG. 1;

FIG. 17 is a bottom and side view of the female fitting for the fuel connector of FIG. 16;

FIG. 18 is a top plan view of the female fitting for the fuel connector of FIG. 16;

FIG. 19 is a bottom plan view of the female fitting for the fuel connector of FIG. 16;

FIG. 20 is a side elevation view of the female fitting for the fuel connector of FIG. 16:

FIG. 21 is a partial sectional view of the female fitting for the fuel connector of FIG. 16;

FIG. 22 is an exploded side view of the female fitting for the fuel connector of FIG. 16;

FIG. 23 is a partial sectional view of the generator of FIG. 1 and the female fitting for the fuel connector of FIG. 16;

FIG. 24 is a partial sectional view of the generator docked to the auxiliary fuel tank of FIG. 2 also illustrating the mating connection of the male and female fittings for the fuel connector;

FIG. 25 is a left elevation view of a portable generator and multiple auxiliary fuel tanks according to one embodiment of the invention wherein the portable generator is undocked from each of the auxiliary fuel tanks;

FIG. 26 is a sectional view of the generator docked to the auxiliary fuel tank as shown in FIG. 2 and taken at 26-26; and

FIG. 27 is a block diagram representation of a portable generator docked to an auxiliary fuel tank according to another embodiment of the invention.

### DETAILED DESCRIPTION OF THE DRAWINGS

The various features and advantageous details of the subject matter disclosed herein are explained more fully with reference to the non-limiting embodiments described in detail in the following description.

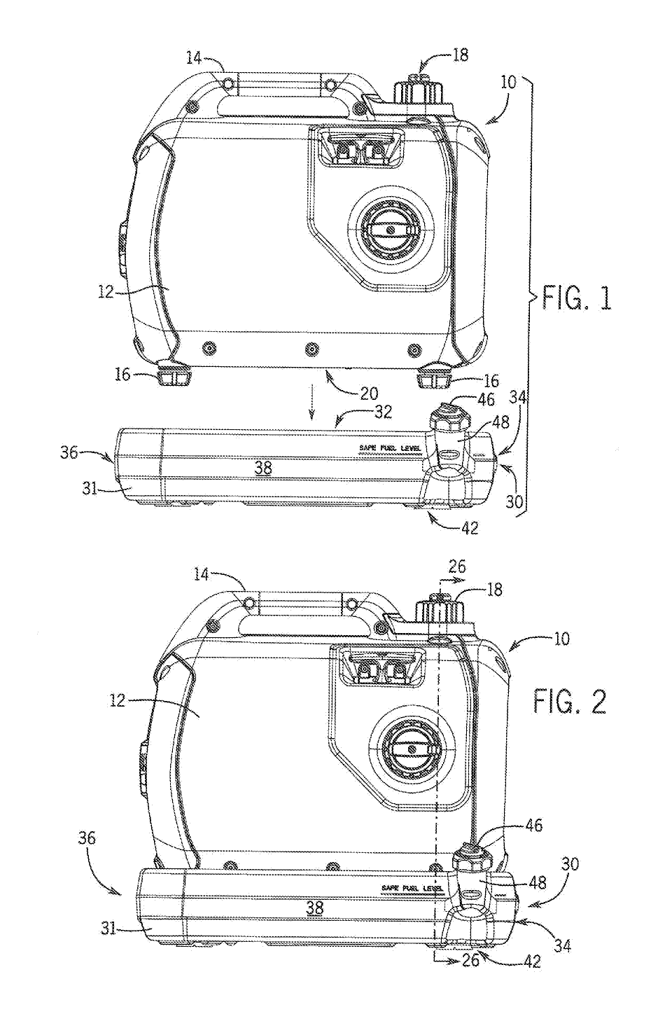

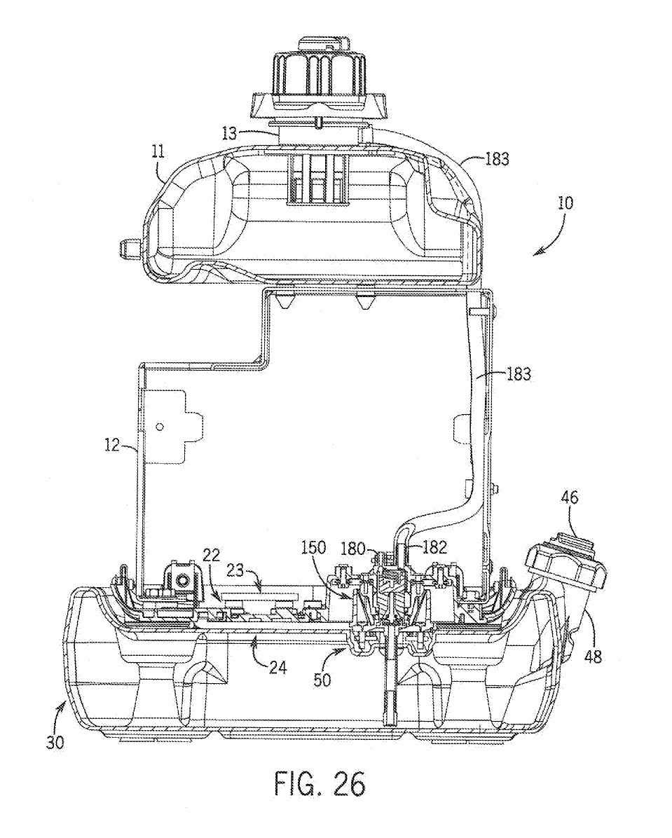

Referring to FIGS. 1 and 2, an auxiliary fuel tank 30 for use with a fuel-powered machine is disclosed. According to the illustrated embodiment, the fuel-powered machine is a portable generator 10. For convenience, the auxiliary fuel tank 30 will be described herein in combination with a portable generator 10. However, it is understood that the auxiliary fuel tank 30 may be used in combination with other fuel-powered machines and, in particular, with other portable fuel-powered machines, such as a pressure washers, heaters, and the like. In FIG. 1, the portable generator 10 is undocked from the auxiliary fuel tank 30. In FIG. 2, the portable generator 10 has been docked to the auxiliary fuel tank 30. The portable generator 10 includes a housing 12 generally enclosing the components of the generator 10. The generator 10 may include, for example, a fuel-driven motor, an alternator, and a controller to control operation of the motor and alternator. The fuel-driven motor receives a start command, for example, from a button or switch on the housing 12 of the generator 10 and begins operation. The motor receives fuel from a main fuel tank 11 (see also FIG. 26) mounted to or integral with the housing 12 of the generator 10. Operation of the motor causes a drive shaft to rotate which is, in turn, coupled to a rotor of an alternator, and rotation of the rotor in the alternator generates electrical energy. The controller may regulate the speed of the motor and/or the output of the alternator to achieve a desired amplitude and frequency of output voltage. The main fuel tank 11 includes a fill neck 13 through which fuel may be received into the tank 11 and a fill cap 18 to close the fill neck 13, preventing spillage and/or contamination of the fuel from the main fuel tank 11. The generator 10 may also include a handle 14 by which the generator may be lifted and/or carried to a desired operating location.

The auxiliary fuel tank 30 holds additional fuel to extend the run time of the portable generator 10. According to the illustrated embodiment, the auxiliary fuel tank 30 is connected to the bottom 20 of the portable generator 10. Optionally, the auxiliary fuel tank 30 may be connected to a side, top, or combination of surfaces of the portable generator 10 without deviating from the scope of the invention. By docking the auxiliary fuel tank 30 to the bottom 20 of the portable generator 10 the stability of the system is improved. The additional weight of the auxiliary fuel tank 30 and the fuel in the auxiliary fuel tank 30 provides a stable base for the portable generator 10. Further, the auxiliary fuel tank 30 elevates the portable generator 10, lifting it away from the ground and from mud, grass, and the like that may be on the ground.

The auxiliary fuel tank 30 is configured to be connected to and removed from the portable generator 10 without tools. Interconnections between the auxiliary fuel tank 30 and the portable generator 10 allow fluid flow paths and electrical connections to be established between the auxiliary fuel tank 30 and the portable generator 10 by placing the portable generator 10 on the auxiliary fuel tank 30. A male electrical connector 24 and a male fuel fitting 50 are mounted to the auxiliary fuel tank 30, and a female electrical connector 22 as well as a female fuel fitting 150 are mounted to the portable generator 10 such that the male and female connectors are in alignment when the portable generator 10 is docked to the auxiliary fuel tank 30. Optionally, the male electrical connector 24, the male fuel fittings 50, or both male connections may be mounted to the portable generator 10 and the corresponding female connection mounted to the auxiliary fuel tank 30.

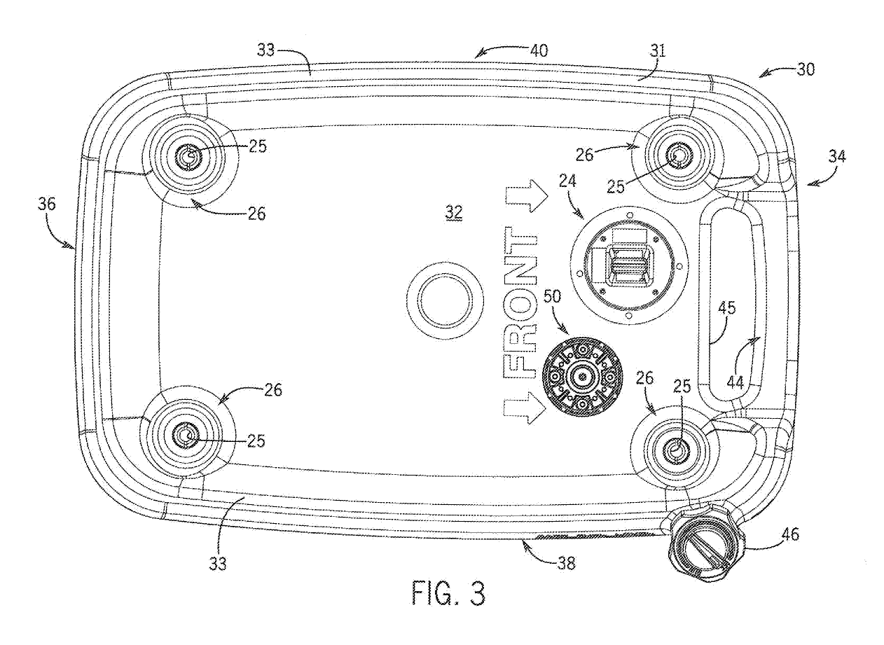

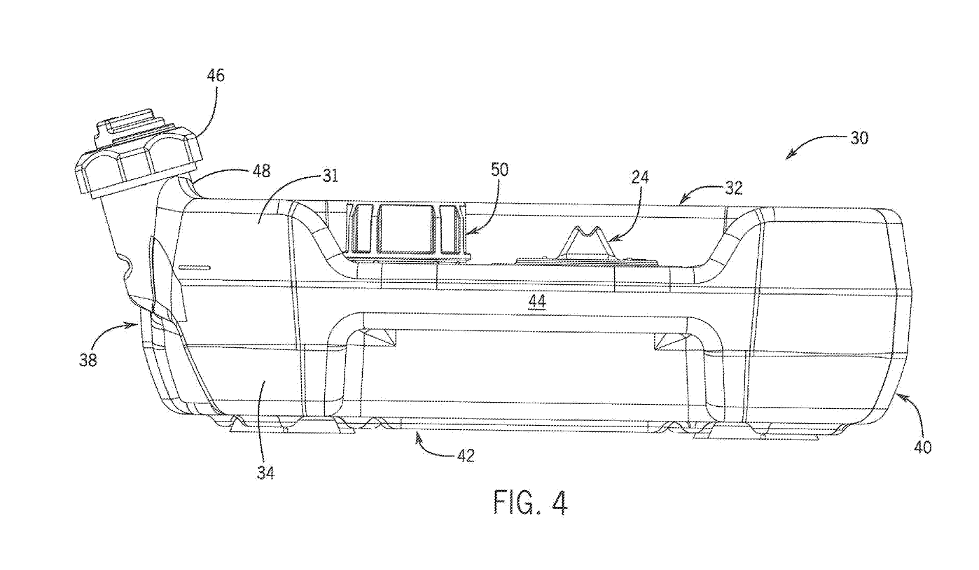

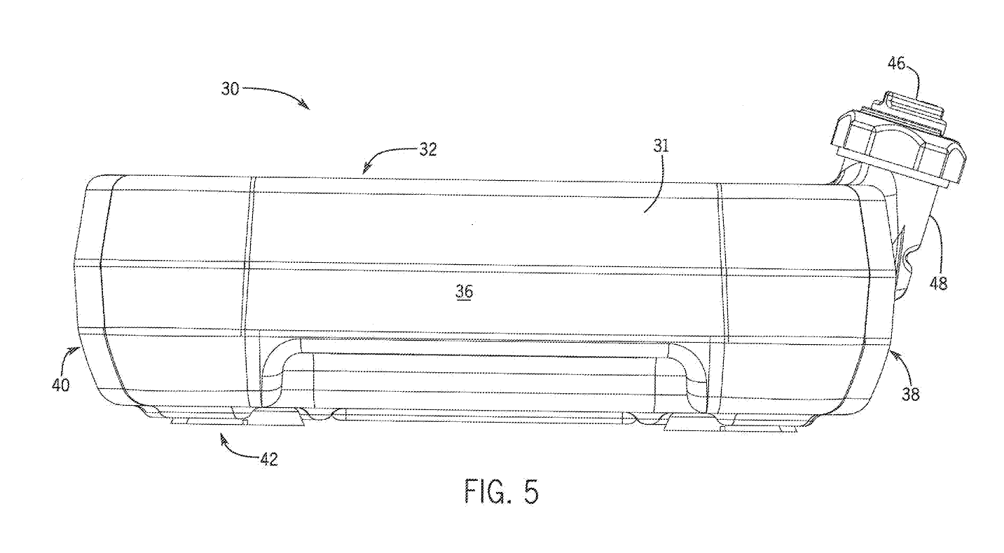

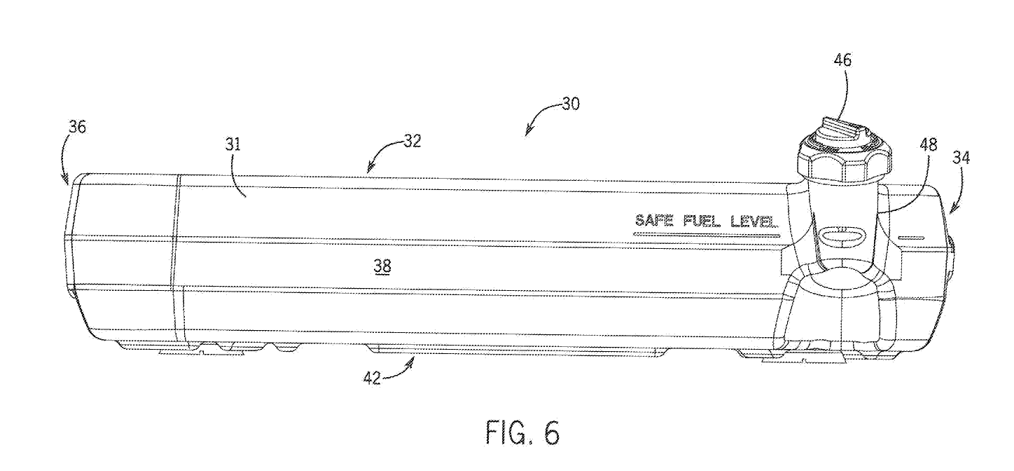

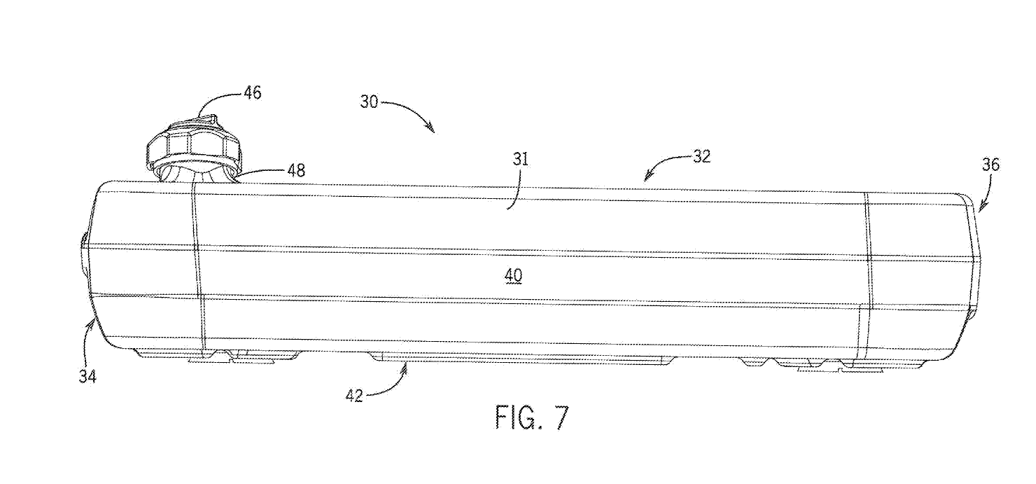

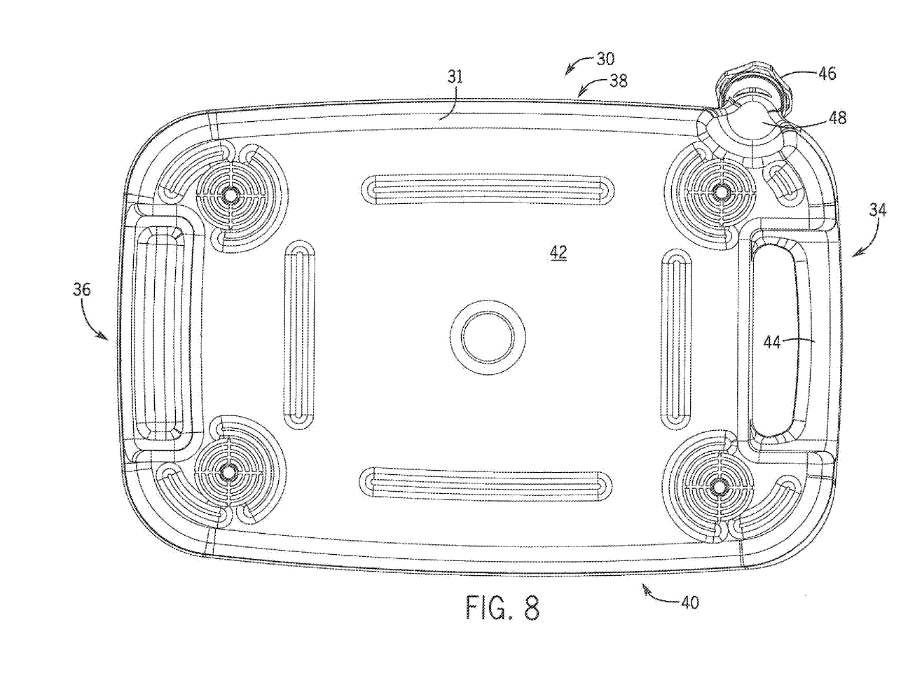

Referring next to FIGS. 3-8, the illustrated embodiment of the auxiliary fuel tank 30 includes an upper surface 32 configured to engage the bottom 20 of the portable generator 10 and a lower surface 42 configured to be placed on another surface on which the portable generator 10 is to rest. A front surface 34, a rear surface 35, a left surface 38, and a right surface 40 extend between the upper surface 32 and the lower surface 42 to generally define an enclosed, interior cavity configured to hold the fuel in the auxiliary fuel tank 30. Each of the front surface 34, rear surface 36, left surface 38, and right surface 40 are joined to the upper surface 32 and the lower surface 42 at rounded edges. Further, each of the front surface 34, rear surface 36, left surface 38, and right surface 40 include a convex curvature extending outward from the center of the auxiliary fuel tank 30. A cavity 45 extends through a portion of the auxiliary fuel tank 30 proximate to the front surface 34 such that a handle 44 is defined, where the outer edge of the handle extends along the front surface 34 of the auxiliary fuel tank 30 and the rear edge of the handle extends along the cavity 45.

A fill neck 48 extends upward from the left surface 38. The fill neck 48 is generally cylindrical. A first end of the fill neck 48 includes an opening in communication with the interior cavity of the auxiliary fuel tank 30, and a second end of the fill neck 48 includes an opening generally open outside of the auxiliary fuel tank 30. The opening on the second end of the fill neck 48 is configured to receive the nozzle of a fuel pump in order to fill the auxiliary fuel tank 30. A cap 46 is removably connected to the fill neck 48 to prevent spillage of the fuel from inside the auxiliary fuel tank 30 and to prevent contamination of the fuel from outside the auxiliary fuel tank 30. A threaded surface may be formed on the interior of the cap 46 and a complementary threaded surface may be formed on the exterior of the fill neck 48 such that the cap 46 may be threaded on to the fill neck 48. Optionally, a clip member (not shown) may be included to positively retain the cap 46 to the fill neck 48. According to still another embodiment, either the cap 46 or the fill neck 48 may include a tab and the other may include a recessed portion or an opening configured to receive the tab. Still other suitable methods of positively retaining the cap 46 to the fill neck 48 may be utilized while allowing the cap 46 to be removed or moved aside from the fill neck 48 in order to allow the nozzle of a fuel pump to be inserted into the fill neck 48.

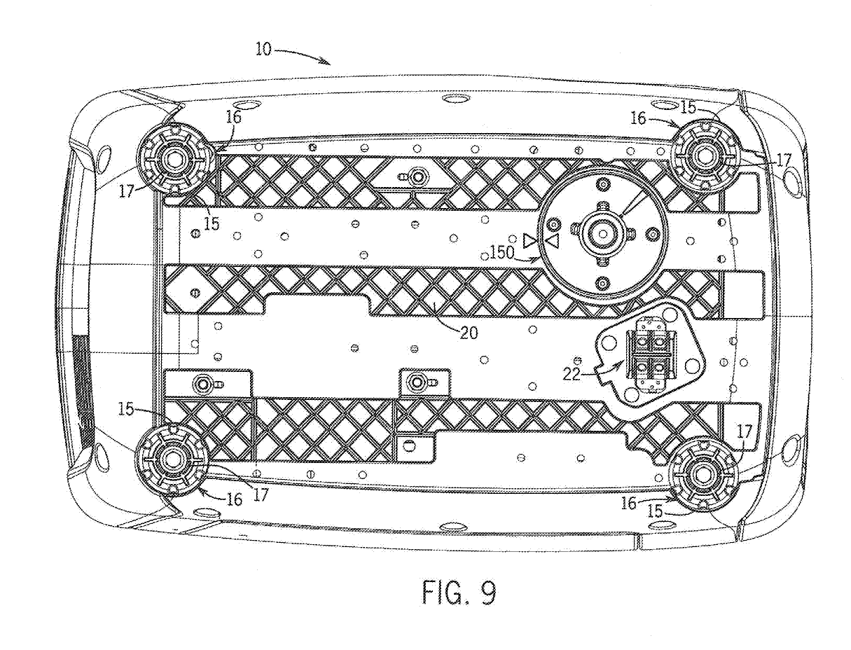

The upper surface 32 of the auxiliary fuel tank 30 is configured to engage the bottom 20 of the portable generator 10. With reference also to FIG. 9, the bottom 20 of the portable generator 10 includes multiple feet 16 configured to engage the ground and to support the portable generator 10 when the auxiliary fuel tank 30 is not present. Each foot 16 is generally circular and protrudes from the bottom 20 of the portable generator 10. Each foot 16 may include a tapered side wall 15 such that the diameter of the foot 16 proximate the bottom 20 of the portable generator 10 is greater than the diameter of the foot 16 at a ground engaging surface 17. A cavity 26 is formed in the upper surface 32 of the auxiliary fuel tank 30 to receive each foot 16. A wall 25 of the cavity 26 extends toward the interior of the auxiliary fuel tank 30 for a distance generally equal to the distance each foot 16 protrudes from the bottom 20 of the portable generator 10. The wall 25 of the cavity 26 may have be tapered complementary to the taper of the foot 16 toward the center of the cavity 26 such that the diameter of the cavity 26 proximate the upper surface 32 of the auxiliary fuel tank 30 is greater than the diameter of the recessed portion of the cavity 26.

The tapers on the side wall 15 of the foot 16 and on the wall 25 of the cavity 26 aid in aligning the portable generator 10 to the auxiliary fuel tank 30. The diameter of the cavity 26 proximate the upper surface 32 of the auxiliary fuel tank 30 is greater than the diameter of the ground engaging surface 17 of the foot 16. Thus, the foot 16 is easily inserted into the cavity 26. As the foot 16 is inserted further into the cavity 26 the side wall 15 of each foot 16 engages the wall 25 of the cavity 26 drawing the portable generator 10 into alignment with the auxiliary fuel tank 30. Thus, the tapers aid in the blind alignment of the portable generator 10 to the auxiliary fuel tank 30 and further aid in aligning male and female fittings 24, 22 of an electrical connector and male and female fittings 50, 150 of a fuel connector between the portable generator 10 and the auxiliary fuel tank 30.

According to the illustrated embodiment, the auxiliary fuel tank 30 may be formed as a single unit. The auxiliary fuel tank 30 may be made from plastic via any suitable molding technique, such as, injection molding or blow molding. Optionally, the auxiliary fuel tank 30 may be molded as multiple components and joined via vibration welding, ultrasonic welding, or by any other suitable method. It is further contemplated that the auxiliary fuel tank 30 may be formed in various other shapes without deviating from the scope of the invention.

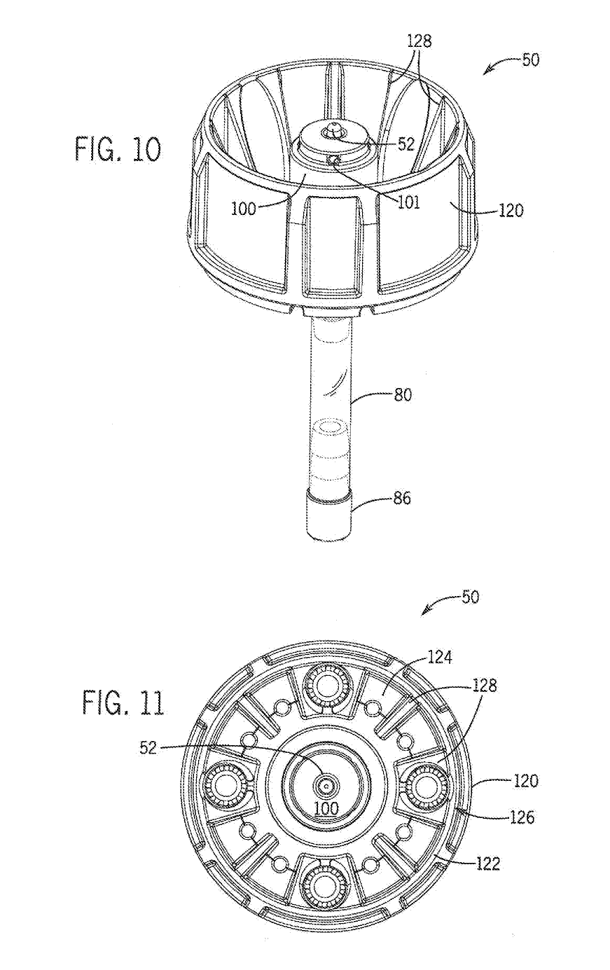

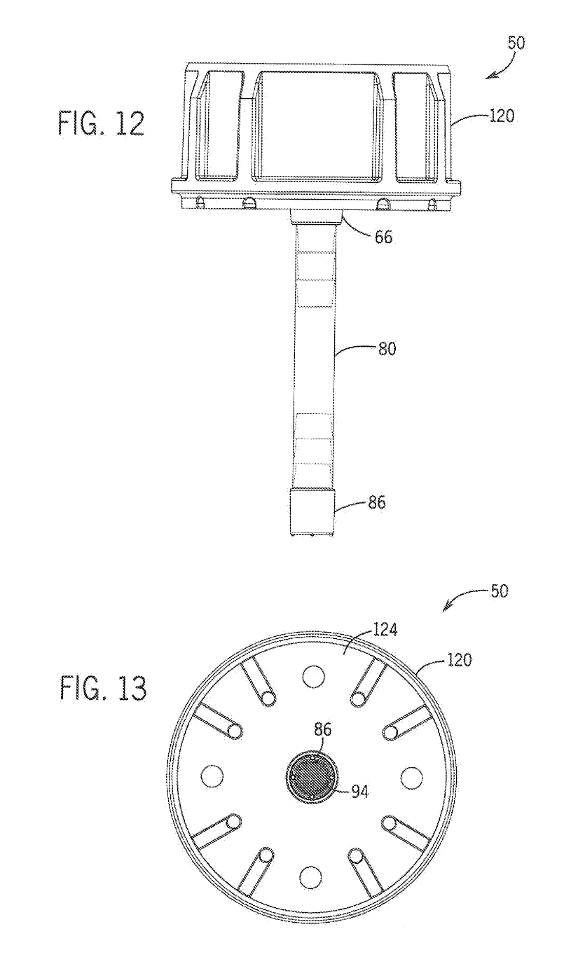

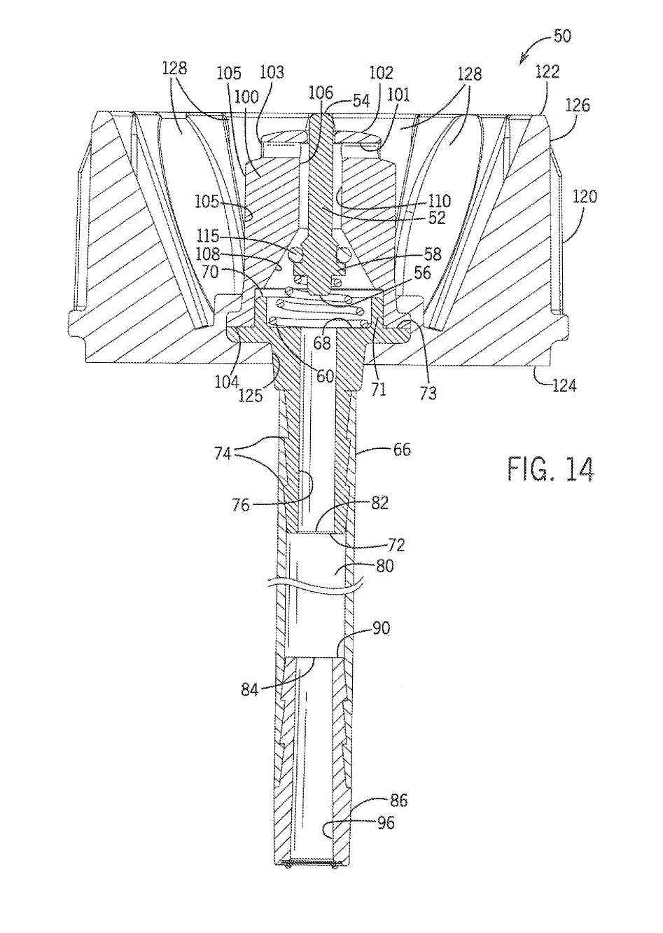

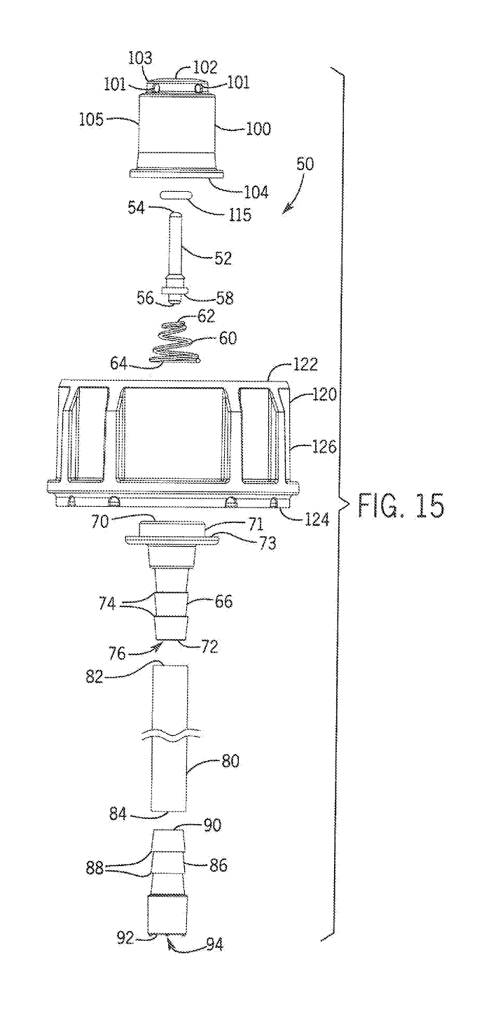

Referring next to FIGS. 10-15, the male fitting 50 of the fuel connector is illustrated. The male fitting 50 is mounted in the auxiliary fuel tank 30 and includes a plunger 52, a conical spring 60, a male barb fitting 66, a pickup tube 80, a pickup filter 86, an O-ring 115, a fuel pin 100, and a fuel fitting protector 120. The plunger 52 includes a first end 54, a second end 56, and is generally cylindrical. A spring seat 58 is located proximate to the second end 56 of the plunger 52. The spring seat 58 is configured to receive a first end 62 of a conical spring 60. The second end 64 of the conical spring 60 is configured to engage a spring seat 68 on the male barb fitting 66. In an uncompressed state, the conical spring 60 biases the plunger 52 away from the male barb fitting 66.

The male barb fitting 66 is configured to hold the pickup tube 80 to the male fitting 50. The male barb fitting 66 has a first end 70, a second end 72 opposite the first end 70, and is generally cylindrical. The spring seat 68 is located proximate to the first end 70, and at least one and preferably multiple barbs 74 protrude outward from the outer periphery of the male barb fitting 66. Bach barb 74 is tapered away from the outer periphery of the male barb fitting 66 with the narrow end of the barb 74 towards the second end 72 and the wide end of the barb 74 towards the first end 70 of the barb fitting 66. The taper of the barbs 74 allow the pickup tube 80 to be press fit onto the male barb fitting 66 with relatively little force while providing a significant resistance to pulling the pickup tube 80 off the male barb fitting 66. The male barb fitting 66 has a generally cylindrical cavity 76 extending there through, defining, at least in part, a flow path for the fuel through the male fuel fitting 50. A first end 82 of the pickup tube 80 is slid onto the male barb fitting 66, and the pickup filter 86 is inserted into the second end 84 of the pickup tube 80.

The pickup filter 86 also includes at least one barb 88 configured to engage the pickup tube 80. The pickup filter 86 includes a first end 90 and a second end 92, where the barbs 88 are located proximate the first end 90. Each barb 88 is tapered away from the outer periphery of the pickup filter 86 with the narrow end of the barb 88 towards the first end 90 and the wide end of the barb 88 towards the second end 92 of the pickup filter 86. The taper of the barbs 88 allow the pickup tube 80 to be press fit onto the pickup filter 86 with relatively little force while providing a significant resistance to pulling the pickup tube 80 off the pickup filter 86. A generally cylindrical cavity 96 extends through the pickup filter 86, defining, at least in part, a flow path for the fuel through the male fuel fitting 50. A filter element 94 may be integrally formed at the second end 92 of the pickup filter 86 across one end of the cavity 96 to prevent contaminants from being drawn into the portable generator 10 through the male fitting 50. Optionally, a removable filter element 94 may be inserted into the cavity 96 of the pickup filter 86.

The male fitting 50 includes a fuel pin 100 configured to help align the male fitting 50 to the female fitting 150 and to protect the plunger 52 in the male fitting 50. The fuel pin 100 is generally cylindrical and has a first end 102 and a second end 104. A first segment 103 of the fuel pin 100 proximate the first end 102 of the fuel pin 100 has a smaller diameter than a second segment 105 of the fuel pin 100. The height of the first segment 103 is sufficient to allow an opening 101 to extend from the exterior of the fuel pin 100 to a cavity 106 within the fuel pin 100. The cavity 106 extends through the fuel pin 100 where a first portion 108 of the cavity 106 is generally conical, having a wider diameter proximate the second end 104 of the fuel pin 100 and a narrower diameter at a point interior to the fuel pin 100. According to the illustrated embodiment, the conical portion 108 extends about halfway into the fuel pin 100. A second portion 110 of the cavity 106 is generally cylindrical. The cylindrical portion 110 of the cavity 106 extends between the conical portion 108 of the cavity 106 and the first end 102 of the fuel pin 100. The diameter of the cylindrical portion 110 is sized to receive the plunger 52 within the cavity 106. Each of the openings 101 is in fluid communication with the second portion 110 of the cavity 106. The cavity 106 and each opening 101 defines a flow path from the second end 104 of the fuel pin 100 up to an inner surface of the first end 102 of the fuel pin 100 and out each of the openings 101.

A cylindrical segment 71 of the male barb fitting 66 proximate the first end 70 may he configured to engage the first portion 108 of the cavity 106. Thus, a complementary segment of the first portion 108 of the cavity at the second end 104 of the fuel pin 100 may also be cylindrical such that the male barb fitting 60 can be press fit into the fuel pin 100. A seating surface 73 on the male barb fitting 66 may extend outward from the cylindrical segment and be configured to engage the second end 104 of the fuel pin 100.

A first assembly for the male fitting 50 may include the plunger 52, conical spring 60, male barb fitting 66, fuel pin 100, and an o-ring 115. The first end 62 of the conical spring 60 is slid over the second end 56 of the plunger 52 to engage the spring seat 58. The diameter of the plunger 52 may be configured to create a friction fit with the interior of the conical spring 60 to aid in retaining the conical spring 60 on the plunger 52. The o-ring 115 is placed over the first end 54 of the plunger 52 and slid down to the spring seat 58 on the opposite surface from the conical spring 60. The plunger assembly may then be inserted into the fuel pin 100, such that the first end 54 of the plunger 52 is inserted into the cavity 106 of the fuel pin. The plunger assembly is inserted until the o-ring engages the surface of the conical portion 108 of the cavity and the first end 54 of the plunger 52 protrudes beyond the first end 102 of the fuel pin 100. The first end 70 of the male barb fitting 66 is then press-fit into the second end 104 of the fuel pin 100 with the second of the conical spring 60 engaging the spring scat 68 of the male barb fitting 66. The conical spring 60 is preferably partially compressed such that the spring 60 exerts a biasing force on the plunger 52 and the o-ring 115 against the surface of the conical portion 108 of the cavity 106, and when the o-ring 115 engages the surface of the conical portion 1108, it seals the cavity 106 preventing fluid from flowing through. This first assembly may then be overmolded by a fuel fitting protector 120.

The fuel fitting protector 120 includes a generally cylindrical outer wall 126 extending orthogonal between a first surface 122 and a second surface 124. The first surface 122 is generally aligned with the first end 54 of the plunger 52 and extends in a narrow band around the periphery of the fuel fitting protector 120. Thus, the cylindrical outer wall 126 helps prevent the first ends of the fuel pin 100 and of the plunger 52 from inadvertently striking or being struck by another object during transport of the auxiliary fuel tank 30. The second surface 124 is a generally planar mating surface configured to engage the upper surface 32 of the auxiliary fuel tank 30. A gasket, o-ring, or other sealing member or compound may be placed between the second surface 124 of the fuel fitting protector 120 and the upper surface 32 of the auxiliary fuel tank 30 to provide a sealed connection between the fuel fitting protector 120 and the auxiliary fuel tank 30. An opening 125 is formed through the central portion of the second surface 124 during the overmolding process and is formed around the first assembly as described above. Multiple ribs 128, interior to the outer wall 126, extend from the first surface 122 into the interior of the fuel fitting protector 120 proximate the first assembly protruding through the interior side of the second surface 124. The ribs 128 are sloped inward from the first surface 122 to the second surface, such that an inner surface of the ribs 128 proximate the first surface 122 have a greater diameter than the inner surface of the ribs 128 proximate the second surface 124. The sloped inner surface of each rib 128 helps align the female fitting 150 of the fuel connector.

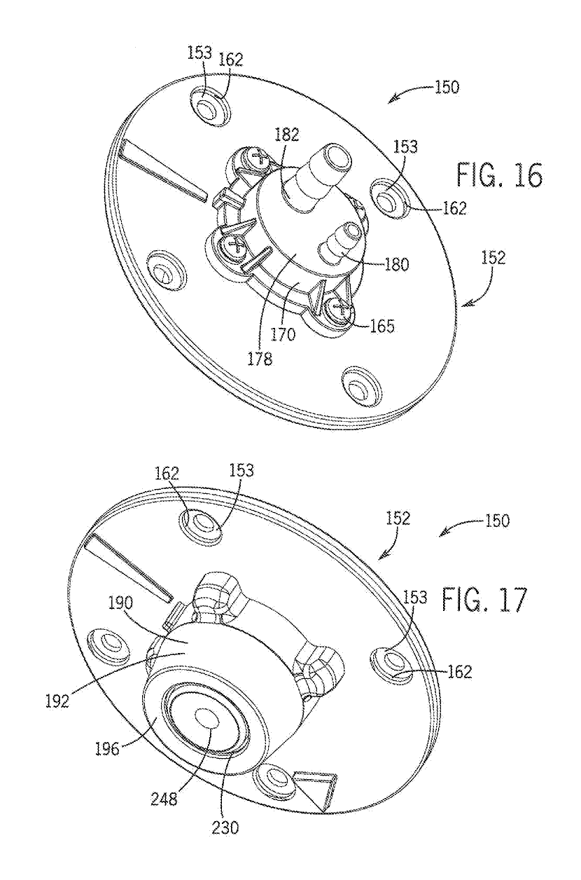

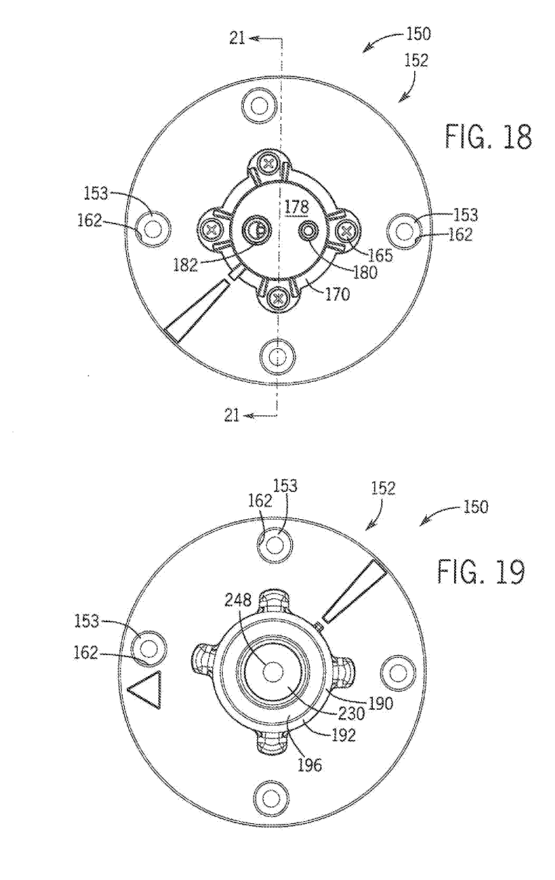

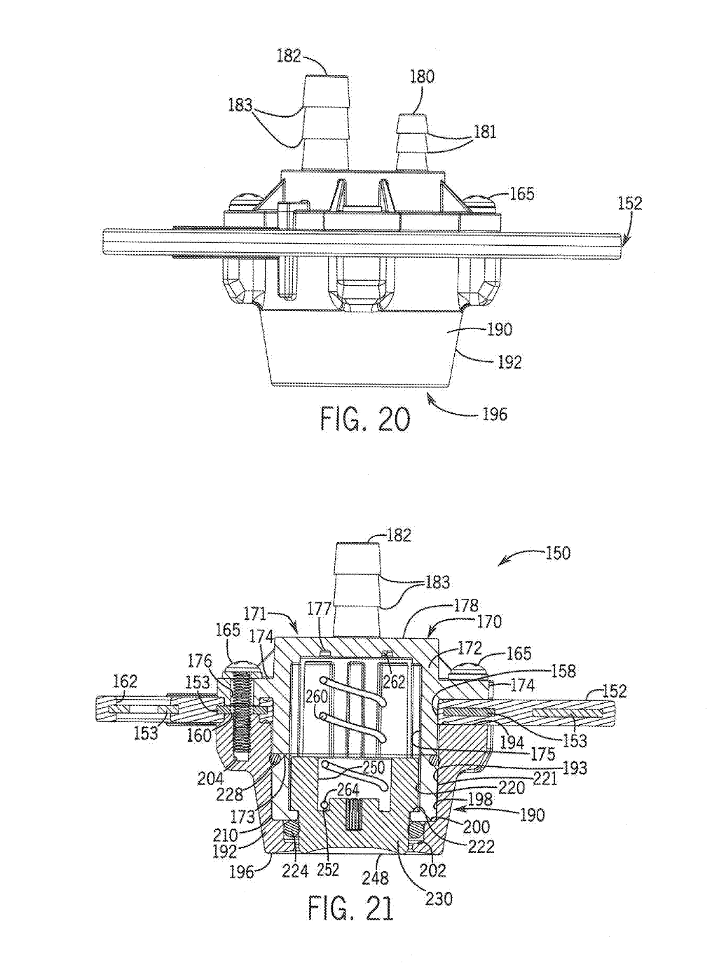

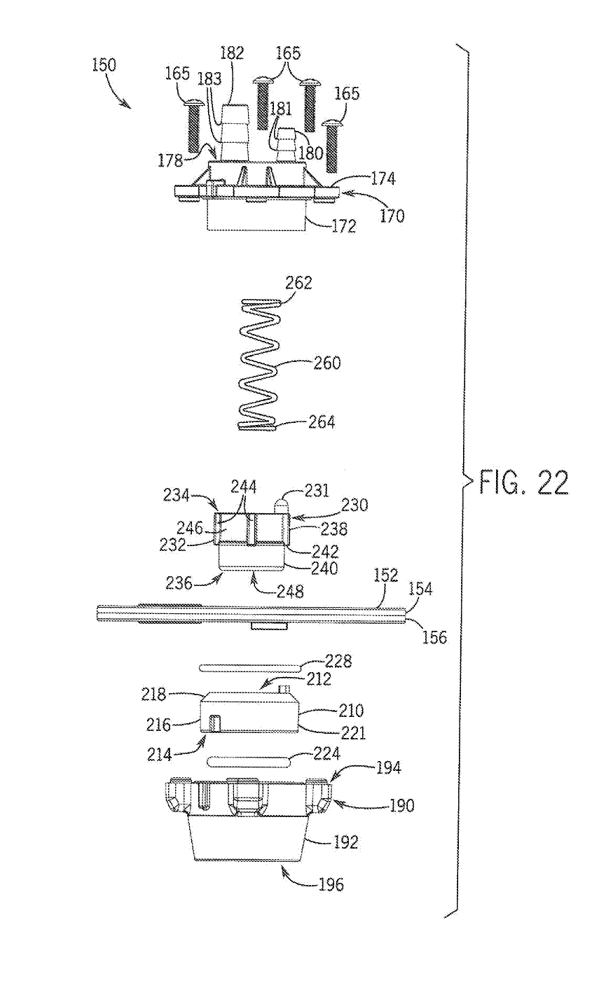

Referring next to FIGS. 16-22, the female fitting 150 of the fuel connector is illustrated. The female fitting 150 is mounted in the portable generator 10 and includes a mounting plate 152, an interior housing 170, an exterior housing 190, a retainer seal 210, a piston 230, a compression spring 260, and a pair of o-rings 224, 228. The interior housing 170 includes a first hose fitting 180 and a second hose fitting 182 extending inward to the housing 12 when the female fitting 150 is mounted to the portable generator 10. The female fitting 150 is operable in one of two operating modes. In the first operating mode, the auxiliary fuel tank 30 is not docked with the portable generator 10. A cavity 175 in the female fitting 150 establishes a first fluid flow path between the first hose fitting 180 and the second hose fitting 182. According to one embodiment of the invention, as shown in FIG. 26, the second hose fitting 182 is connected to the main fuel tank 11 of the portable generator 10 and the first hose fitting 180 is exposed or connected to ambient air. This first fluid flow path provides ventilation to the main fuel tank 11 via the female fitting 150 when the auxiliary fuel tank 30 is not docked to the portable generator 10. In the second operating mode, the auxiliary fuel tank 30 is docked with the portable generator 10. The female fitting 150 blocks the first fluid flow path and establishes a second fluid flow path between the second hose fitting 182, connected to the main fuel tank 11, and the male fitting 50 mounted to the auxiliary fuel tank 30. This second fluid flow path allows the portable generator 10 to siphon fuel from the auxiliary fuel tank 30 into the main fuel tank for use by the portable generator 10.

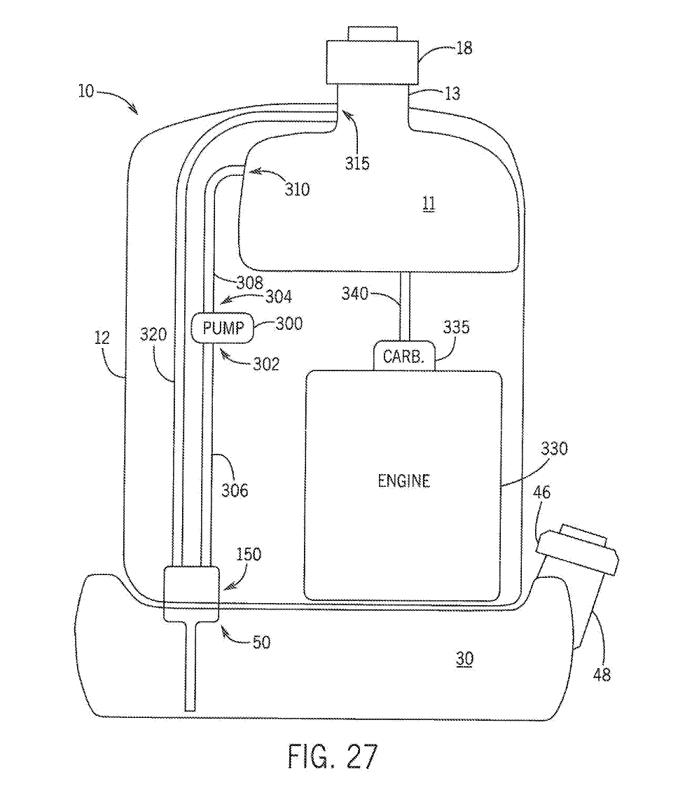

According to another embodiment of the invention, as shown in FIG. 27, a pump 300 may be used to transfer fuel from the auxiliary fuel tank 30 to the main fuel tank 11. The pump 300 may have an inlet 302 and an outlet 304, where fuel is drawn into the inlet 302 of the pump and delivered from the outlet 304 of the pump via operation of the pump 300. A first fuel line 306 may be connected between one of the hose fittings 180, 182 on the female fitting 150 and the inlet 302 of the pump 300, and a second fuel line 308 may be connected between the outlet 304 of the pump 300 and an inlet 310 on the main fuel tank 11. It is contemplated that the main fuel tank 11 may include a float switch, sending a signal to the logic circuit 23 (see FIG. 26) corresponding to the level of fuel present in the main fuel tank 11. Similarly, the auxiliary fuel tank 30 may include a float switch, sending a signal to the logic circuit 23 via the electrical connector corresponding to the level of fuel present in the auxiliary fuel tank 11. The signals from each of the float switches in the main and auxiliary fuel tanks 11 may be used to control operation of the pump 300. The main fuel tank 11 may also include an overflow outlet 315 and a third fuel line 320 connected between the overflow outlet 315 and the other of the hose fittings 180, 182 on the female fitting 150 to return excessive fuel from the main fuel tank 11 to the auxiliary fuel tank 30. The main fuel tank 11 may be located at the top of the housing 12 for the portable generator such that another fuel line 340 may deliver the fuel from the main fuel tank 11 to a carburetor 335, or other fuel regulation device, on the engine 330 via a gravity feed.

The female fitting 150 includes a mounting plate 152 by which the female fitting is mounted to the portable generator 10. According to the illustrated embodiment, the mounting plate 152 is a resilient material to provide an isolation mount for the female fitting 150 to the portable generator 10. The mounting plate 152 may be molded over rigid inserts 153 or, optionally, the mounting plate 152 may be formed from a first layer 154 and a second layer 156 joined together around the rigid inserts 153, where the two layers 154, 156 are joined via adhesive, pressure, melting, or a combination thereof. The mounting plate 152 is generally, planar and circular in form with a first, circular opening 158 extending through the center. A series of second openings 160 are positioned around the first opening 158. As illustrated, four circular second openings 160 are spaced about the first opening 158. It is contemplated that the second openings 160 may be spaced, for example, at ninety degree intervals. Optionally, one of the second openings 160 may be spaced, for example, at eighty degrees from one adjacent second opening 160 and at one hundred degrees from the other adjacent second opening 160. Utilizing non-uniform spacing of the second openings 160 provides a guide for a desired alignment of the housing members 170, 190 with respect to each other. One of the inserts 153 is disposed within each of the second openings 160. The second openings 160 are configured to receive a fastening member, such as a screw 165, extending through the mounting plate 152 to secure the housing members 170, 190 to each side of the mounting plate 152. The mounting plate 152 also includes a series of third openings 162 extending through the mounting plate 152 disposed radially outward from the second openings 160. The third openings 162 are configured to receive a fastening member, such as a screw to secure the female fitting 150 to the portable generator 10. Each of the third openings 162 also includes a rigid insert 153. It is understood that the illustrated openings 158, 160, 162 through the mounting plate 152 describe one embodiment of the present invention and that various other numbers, shapes, and arrangements of openings may be utilized through the mounting plate 152 without deviating from the scope of the invention.

An interior housing 170 and an exterior housing 190 are placed on each side of the mounting plate 152 and joined by the screws 165 extending through each of the interior housing 170, exterior housing 190, and mounting plate 152. The interior housing 170 and exterior housing 190 are defined as such with reference to being located interior and exterior to the portable generator 10 when the female fitting 150 is mounted to the portable generator 10 and not with respect to one housing being located or positioned within or around the other.

The interior housing 170 includes a generally cylindrical side wall 172 having a first edge 171 and a second edge 173 at opposite ends of the side all 172, where the cylindrical side wall 172 defines, at least in part, a cavity 175 within the interior housing 170. An end wall 178 extends orthogonally across the cavity 175 defined by the first edge 171 of the cylindrical side wall 172. A first hose fitting 180 and a second hose fitting 182 protrude from the end wall 178. Each of the first and second hose fittings 180, 182 include barbs 181, 183 protruding outward from the respective hose fitting 180, 182. Each barb 181, 183 is tapered away from the outer periphery of the hose fitting 180, 182 with the narrow end of each barb 181, 183 distal from the end wall 178 and the wide end of each barb 181, 183 proximal to the end wall 178. The taper of the barbs 181, 183 allow tubes or hoses to be press fit onto the barb 181, 183 with relatively little force while providing a significant resistance to pulling the tube or hose off. A mounting wall 174 extends radially outward from the cylindrical side all 172. The mounting wall 174 engages the mounting plate 152. Multiple openings 176 extend through the mounting wall 174 and are arranged to be aligned with the second openings 160 in the mounting plate 152. The second edge 173 of the cylindrical side wall 172 is configured to be inserted through the opening 158 in the mounting plate 152. The second edge 173 is open to the cavity 175 within the interior housing 170 and is configured to be received in open end of the exterior housing 190.

The exterior housing 190 includes a side wall 192 extending between a first end 194 and a second end 196 of the exterior housing 190. The side wall 192 includes a generally cylindrical inner periphery 193, which defines, at least in part, a cavity 198 within the exterior housing 190. The diameter of the inner periphery 193 proximate the first end 194 of the exterior housing 190 corresponds to an outer diameter of the side wall 172 for the interior housing 190 such that the side wall 172 of the interior housing may be inserted into the cavity 198 defined by the side wall 192 of the exterior housing 190. A first seat 200 and a second seat 202 are located around the inner periphery 193 proximate the second end 196 of the exterior housing 190. The first seat 200 extends into the cavity 198 a first distance and the second seat 202 extends into the cavity 198 a second distance, where the second distance is greater than the first distance. The first seat 200 is configured to provide a positive stop for a retainer seal 210 inserted into the exterior housing 190 and the second seat 202 is configured to provide a positive stop for an o-ring 224 inserted into the exterior housing 190. The first end 194 of the exterior housing 190 includes multiple recesses 204 which may be threaded or include a threaded insert. Each of the recesses 204 is aligned with one of the second openings 160 in the mounting plate 152 and one of the openings 176 in the interior housing 170 to receive one of the screws 165 securing the interior housing 170 and the exterior housing 190 to the mounting plate 152.

The retainer seal 210 includes a side wail 216 extending between a first end 212 and a second end 214 of the retainer seal 210. The outer periphery 221 of the side wall 216 of the retainer seal 210 is generally cylindrical and is configured to engage the 193 inner periphery of the exterior housing 190. The inner periphery 220 of the side wall 216 of the retainer seal 210 is generally cylindrical and is configured to slidably receive a piston 230. A seat 222 protrudes orthogonally inward from the inner periphery 220 of the side wall, providing a stop for the piston 230 at the second end 214 of the retainer seal 210. The second end 214 of the retainer seal 210 is also configured to engage the first seat 200 of the exterior housing 190. The seat 222 on the retainer seal 210 extends inward about the same distance as the second seat 202 of the exterior housing 190 such that the outer surface of the seat 222 on the retainer seal 210 and the second seat 202 of the exterior housing 190 retain a first o-ring 224 therebetween. The outer periphery 221 of the retainer seal 210 includes a beveled surface 218 proximate the first end 212. The beveled surface 218 of the retainer seal 210, the second edge 173 of the interior housing 170, and the inner periphery 193 of the exterior housing 190 define a cavity where the three pieces meet, in which, a second o-ring 228 is seated.

The piston 230 includes a side wall 232 extending between a first end 234 and a second end 236 of the piston. The side wall 232 has a first segment 238 extending between the first end 234 of the piston 230 and a shelf 242 and a second segment 240 extending between the shelf 242 and the second end 236 of the piston 230. The first segment 238 includes a series of alternating ribs 244 and recessed segments 246. The outer surface of the ribs 244 are configured to slidably engage the cavity 175 of the interior housing 170 and the inner periphery 220 of the retainer seal 210. Each recessed segment 246 extends into the side wall 232 for a portion of the thickness the side wall 232 and defines, in part, a flow path for fuel between the auxiliary fuel tank 30 and the portable generator 10. The outer surface of the second segment 240 is generally cylindrical and has a diameter less than the diameter of the first segment 238. The shelf 242 extends orthogonally between the first segment 238 and the second segment 240 and is configured to engage the seat 222 on the retainer seal 210. The second end 236 of the piston 230 includes a cap 248 configured to engage the male fitting 50 of the fuel connector as the male fitting 50 is inserted into the female fitting 150. The first end 234 of the piston 230 is open to a cavity 250 within the piston 230. The cavity 250 extends for a portion of the height of the piston 230 and includes a spring seat 252 at the inner surface of the cavity 250. The spring seat 252 is configured to receive a second end 264 of a compression spring 260 mounted internal to the female fitting 150. The first end 262 of the compression spring 260 engages a spring seat 177 on the inner surface of the end wall 178 for the interior housing 170. The first end 234 of the piston 230 also includes a plug 231. The plug 231 is oriented on the piston 230 to engage and to block the first hose fitting 180 when the piston 230 is pushed into the cavity 175 of the interior housing 170.

According to the illustrated embodiment, assembly of the female fitting 150 includes inserting the first o-ring 224 into the exterior housing 190 such that it rests against the second seat 202. The retainer seal 210 is then inserted into the exterior housing 190 until it rests against the first seat 200 and the seat 222 of the retainer seal 210 and the second seat 202 of the exterior housing 190 are on opposite sides of the first o-ring 224. The second o-ring 228 is inserted into the exterior housing 190 and fit around the beveled surface 218 of the retainer seal 210. Next the piston 230 is inserted into the retainer seal 210 until it rests against the seat 222 of the retainer seal 210. The compression spring 260 is inserted into the cavity 250 and against the spring seat 252 in the back of the piston 230. The first end 194 of the exterior housing 190 may be placed against the mounting plate 152 with the compression spring 260 extending through the first opening 158 in the mounting plate 152. The second edge 173 of the interior housing 170 is fit thorough the first opening 158 in the mounting plate and into the exterior housing 190 such that the first end 262 of the compression spring 260 is received into the cavity 175 and engages the spring seat 177 in the interior housing 170. Each of the recesses 204 of the exterior housing is aligned with one of the second openings 160 in the mounting plate 152 and one of the openings 176 in the interior housing 170, and one of the screws 165 is threaded through each of the openings to secure the interior housing 170 and the exterior housing 190 to the mounting plate 152.

In operation, the fuel connector allows the auxiliary fuel tank 30 to be docked with and removed from the portable generator 10 without the use of tools and without requiring additional hoses or connections to be connected between the auxiliary fuel tank 30 and the portable generator 10. To dock the portable generator 10 on the auxiliary fuel tank 30, the auxiliary fuel tank 30 may first be placed on a desired surface or ground on which the docked generator 10 and tank 30 will operate. The portable generator 10 is lifted up and positioned above the auxiliary fuel tank 30. The portable generator 10 is then set down on to the auxiliary fuel tank 30.

With reference again to FIGS. 3 and 9, as the portable generator 10 is lowered to the auxiliary fuel tank 30 each of the interconnections between the two devices help align the portable generator 10 in the correct position to be docked with the auxiliary fuel tank 30. Each of the feet 16 on the portable generator 10 begins to be inserted into one of the cavities 26 on the upper surface 32 of the auxiliary fuel tank 30. As the foot 16 moves further into the cavity 26, the side wall 15 of the foot 16 engages the wall 25 of the cavity 26. The walls 25 of the cavity 26 guide the foot 16 into the cavity 26 until it is fully inserted into the cavity 26 and the portable generator 10 rests on the auxiliary fuel tank 30. Similarly, the first segment 103 of the fuel pin 100, which is narrower in diameter than the second segment 105, engages the cap 248 of the piston 230 and begins to push the piston 230 into the interior of the female fitting 150. The tapered ribs 128 on the interior portion of the fuel fitting protector 120 for the male fitting 50 engage the outer periphery of the side wall 192 on the exterior housing 190 for the female fitting 150. The outer periphery of the side wall 192 for the exterior housing 190 has a slope complementary to the slope of the tapered ribs 128. As the male fitting 50 and the female fitting 150 are coupled together, the tapered ribs 128 and the side wall 192 for the exterior housing 190 help align the fuel connector. The male connector 24 and female connector 22 for the electrical connector similarly include complementary tapered surfaces to help draw the two pieces of the electrical connector as well as the portable generator 10 and the auxiliary fuel tank 30 into alignment.

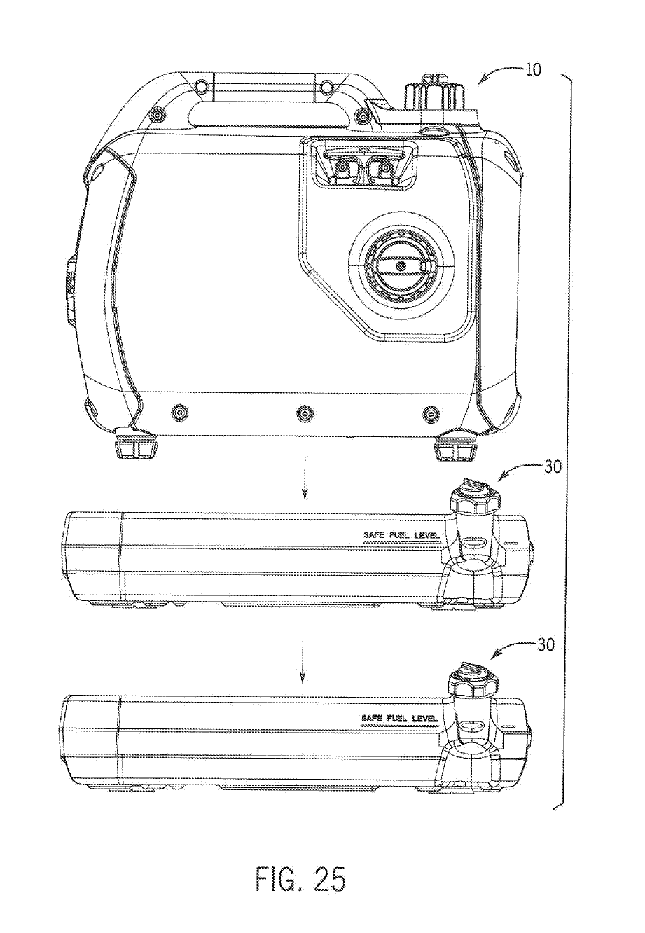

With reference also to FIG. 25, it is contemplated that multiple auxiliary fuel tanks 30 may be connected to the portable generator 10. The upper surface 32 of each auxiliary fuel tank also includes a rim 33 extending around the periphery of the upper surface 32. Each of the side walls of the auxiliary fuel tank 30 may be sloped inward, such that the periphery of the lower surface 42 of the auxiliary fuel tank 30 fits within the periphery of the rim 33 on the upper surface 32. A female fuel fitting 150 and a female electrical connector 22 may be mounted to the lower surface 42 of a first auxiliary fuel tank 30 to mate with the male fuel fitting 50 and the male electrical connector 24 on the top of a second auxiliary fuel tank 30. Appropriate interconnections may be made internal to the first auxiliary fuel tank 30 to establish electrical connections and fuel flow paths between the portable generator 10 and each of the auxiliary fuel tanks 30 stacked below it. Stacking multiple auxiliary fuel tanks 30 may further increase the run time of the portable generator 10.

Optionally, the rim 33 extending around the periphery of the upper surface 32 may be used to aid in stacking multiple auxiliary fuel tanks 30 with no connectors on the bottom surface. In this arrangement, multiple auxiliary fuel tanks 30 are provided, where one auxiliary fuel tank 30 is connected to the portable generator 10 at a time and the remaining auxiliary fuel tanks 30 are stored in a stack wider the portable generator 10. As each auxiliary fuel tank 30 is emptied, the portable generator 10 may be lifted from the stack of auxiliary fuel tanks 30, the empty auxiliary fuel tank 30 moved down in the stack and a full auxiliary fuel tank 30 moved to the top of the stack. The portable generator 10 is set back onto the full auxiliary fuel tank 30 and operation resumed.

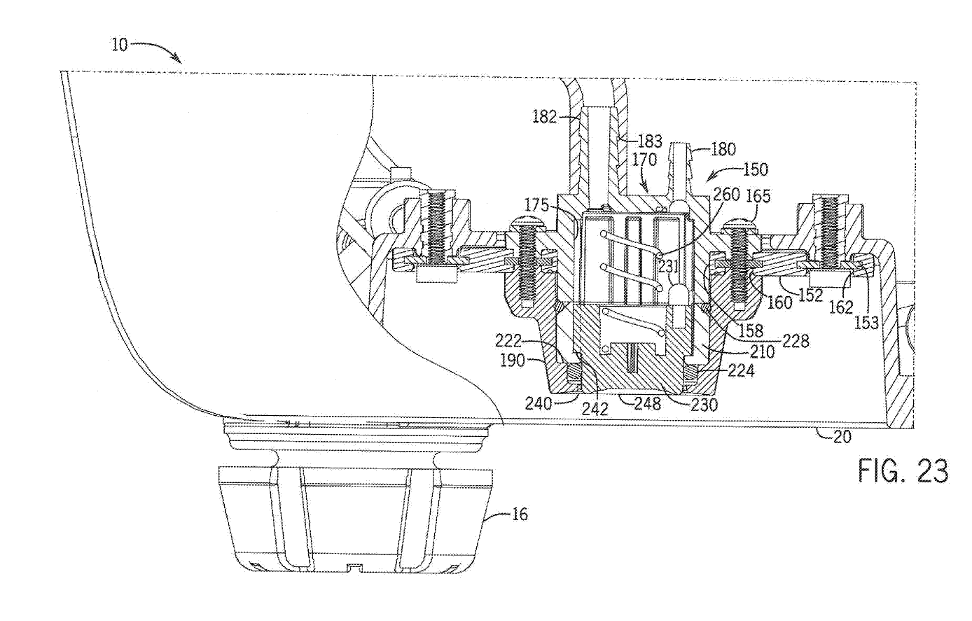

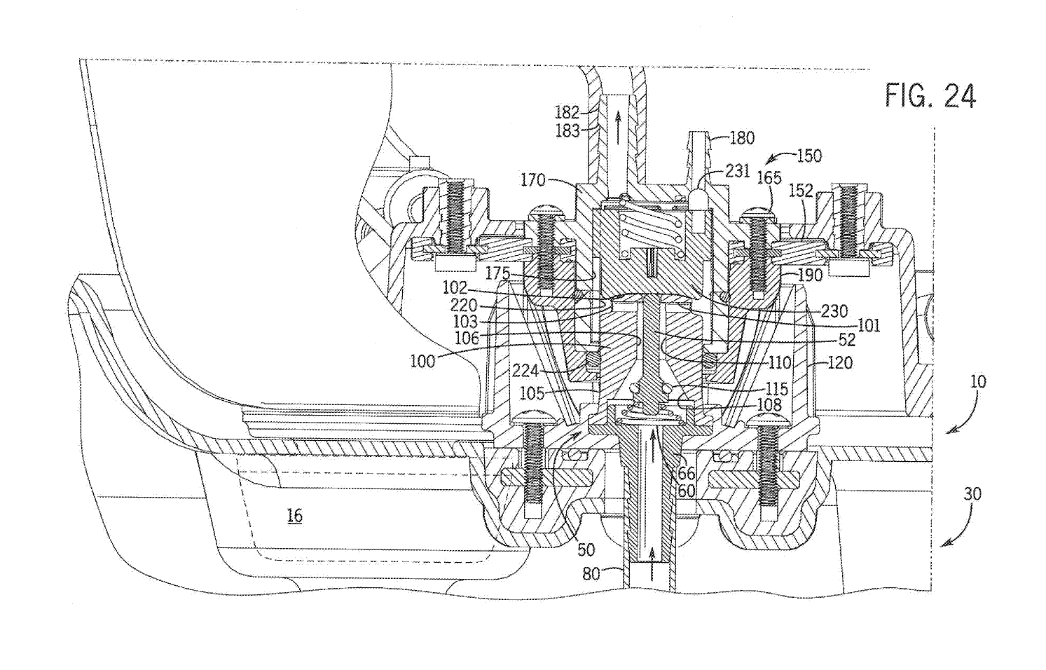

Referring next to FIGS. 23 and 24, operation of the fuel connector between the portable generator 10 and the auxiliary fuel tank 30 is illustrated. In FIG. 23, the auxiliary fuel tank 30 is not docked with the portable generator 10. The compression spring 260 biases the piston 230 toward the bottom 20 of the portable generator 10. The shelf 242 of the piston 230 is pressed against the seat 222 on the retainer seal 210. In addition, the second segment 240 of the side wall 232 for the piston 230 engages one of the o-rings 224 in the female fitting 150. The combination of the o-ring 224 engaging the piston 230 and shelf 242 being pressed against the seat 222 establish a seal at the bottom of the female fitting 150, preventing air, fluids, or other contaminants from entering the main fuel tank of the portable generator 10 when the auxiliary fuel tank 30 is not docked. The sealing arrangement also prevents fuel from the main fuel tank or residual fuel within, for example, the cavity 175 of the interior housing from spilling out of the portable generator 10. One end of a tube (not shown) may be attached to the first hose fitting 180 with the other end of the tube positioned either within the housing of the portable generator 10 or extending to an opening in the housing to provide access to the ambient air outside the portable generator 10. When the portable generator 10 is running without the auxiliary fuel tank 30 docked, a first fluid flow path is established through the tube and the first hose fitting 180 into the cavity 175 of the interior housing 170. The flow path continues out of the cavity 175 via the second hose fitting 182 and a tube 183 connected to the second hose fitting 182. This first flow path acts as a vent to the main fuel tank, allowing vapors within the main fuel tank to escape to the ambient air and to allow ambient air to be drawn into the main fuel tank as fuel is consumed.

In FIG. 24, the auxiliary fuel tank 30 has been docked to the portable generator 10. The first end 54 of the plunger 52, which protrudes beyond the first end 102 of the fuel pin 100, engages the piston 230 in the female fitting 150. The bias force of the compression spring 260 in the female fitting 150 is greater than the bias force of the conical spring 60 in the male fitting 50 such that the plunger 52 is forced into the fuel pin 100 during insertion of the male fitting 50 into the female fitting 150, establishing a fuel flow path around the o-ring 115 and up through the second portion 110 of the cavity 106 of the fuel pin 100. The first end 102 of the fuel pin 100 then engages the piston 230 to continue pushing the piston 230 up into the cavity 175 of the interior housing 170. As the male fitting 50 moves further into the female fitting 150, the outer surface of the second segment 105 of the fuel pin 100 engages the o-ring 224 to prevent fluid flow between the exterior of the fuel pin 100 and the female fitting 150. Also, the plug 231 on the piston 230 is inserted into the back of the first hose fitting 180, blocking the first flow path between the cavity 175 and the ambient air.

With the portable generator 10 resting on the auxiliary fuel tank 30, the male fitting 50 fully engages the female fitting 150 to establish a fluid flow path for the fuel from the auxiliary fuel tank 30 to the main fuel tank in the portable generator 10. Because the first flow path between the ambient air and the main fuel tank is blocked, fuel is siphoned up from the auxiliary fuel tank 30 through the second hose fitting 182. Fuel is drawn up through the pickup filter 86, pickup tube 80, and male barb fitting 66 into the cavity 106 of the fuel pin 100. Fuel flows up around the o-ring 115 and the base of the plunger 52 in the conical portion 108 of the cavity 106 and then up and around the plunger 52 within the cylindrical portion 110 of the cavity. Fuel exits the fuel pin 100 via the openings 101 proximate the first end of the fuel pin 100 and enters the female fitting 150. The second flow path for the fuel continues within the space defined by the inner periphery 220 of the retainer seal 210 and the cavity 175 in the interior housing 170. Fuel flows through the recessed segments 246 between the piston 230 and the inner surface of the side wall 172 for the interior housing 170. Once above the piston 230, the fuel is drawn into the second hose fitting 182 to be conveyed to the main fuel tank. The siphon action allows fuel to be drawn from the auxiliary fuel tank 30 into the main fuel tank of the portable generator 10 and, in turn, be used to operate the engine of the portable generator 10.

The siphon is generated by a vacuum being established in the main fuel tank. The cap 18 on the main fuel tank is not vented. As discussed above, the main fuel tank is vented via the first flow path through the female fitting 150 between the ambient air and the main fuel tank when the auxiliary fuel tank 30 is not docked. When the auxiliary fuel tank 30 is docked, the first flow path is blocked. As fuel is consumed in the main fuel tank, a vacuum is established. The fuel cap 46 on the auxiliary fuel tank 30 is vented, to allow air into and to maintain a positive pressure within the auxiliary fuel tank 30 as fuel is consumed, such that the fuel is drawn through the second flow path to the main fuel tank.

The male connector 24 and female connector 22 for the electrical connector between the auxiliary fuel tank 30 and the portable generator 10 provide an electrical connection by which a signal may be passed between the auxiliary fuel tank 30 and the portable generator 10. For example, a fluid level sensor such as a float sensor may be provided in the auxiliary fuel tank 30 and generate a signal corresponding to the level of fuel in the auxiliary tank 30. The signal may be passed through the electrical connector to a logic circuit 23 in the portable generator. The logic circuit 23, in turn, controls operation of the portable generator 10.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A fuel storage system for a fuel-powered machine, the fuel storage system comprising:
a housing integrally mounted to the fuel-powered machine, the housing including a first opening;
a first fuel tank mounted to the housing and in fluid communication with the fuel-powered machine;
a first portion of a fuel fitting accessible through the first opening; and
at least one auxiliary tank removably mounted to the housing, the auxiliary tank including:
a housing having a second opening, and
a second portion of the fuel fitting accessible through the second opening, wherein when the auxiliary tank is mounted to the fuel-powered machine, the second portion of the fuel fitting operatively engages the first portion of the fuel fitting to establish a fluid flow path between the auxiliary tank and the first fuel tank.

2. The fuel storage system of claim 1 wherein the fuel-powered machine includes a control circuit, the housing integrally mounted to the fuel-powered machine includes a third opening and the housing on the at least one auxiliary tank includes a fourth opening, the fuel storage system further comprising:
a first portion of an electrical connector accessible through the third opening;
a second portion of the electrical connector accessible through the fourth opening; and
at least one sensor mounted in the auxiliary tank, wherein when the auxiliary tank is mounted to the fuel-powered machine, the second portion of the electrical connector operatively engages the first portion of the electrical connector to establish an electrical connection between the at least one sensor and the control circuit.

3. The fuel storage system of claim 1 wherein the fuel-powered machine includes a plurality of feet for supporting the fuel-powered machine and an upper surface of the housing for the at least one auxiliary tank includes a plurality of cavities, each cavity operable to receive one of the plurality of feet when the auxiliary tank is mounted to the fuel-powered machine.

4. The fuel storage system of claim 1 wherein:
the housing on the at least one auxiliary tank includes a first surface and a second surface opposite the first surface,
the second opening is located in the first surface,
the housing includes a third opening in the second surface,
the at least one auxiliary tank includes a first portion of the fuel fitting accessible through the third opening, such that a first auxiliary tank, selected from the at least one auxiliary tank, is mounted to the housing integrally mounted to the fuel-powered machine and a second auxiliary tank, selected from the at least one auxiliary tank, is mounted to the housing of the first auxiliary tank, and
when the second auxiliary tank is mounted to the first auxiliary tank, the second portion of the fuel fitting in the second auxiliary tank operatively engages the first portion of the fuel fitting in the first auxiliary tank to establish a fluid flow path between the second auxiliary tank and the first auxiliary tank.

5. The fuel storage system of claim 1 wherein the first fuel tank includes a passage providing a fluid flow path to ambient air when auxiliary tank is not mounted to the first fuel tank and wherein the fuel fitting blocks the passage when the auxiliary tank is mounted to the first fuel tank.

6. The fuel storage system of claim 5 wherein the auxiliary tank is vented to the ambient air such that when the auxiliary tank is mounted to the first fuel tank and fuel is consumed from the first fuel tank by the fuel-powered machine, a vacuum is established between the first fuel tank and the auxiliary fuel tank to draw fuel from the auxiliary fuel tank into the first fuel tank.

7. The fuel storage system of claim 1 wherein the fuel storage system further comprises a pump mounted within the housing, the pump including an inlet and an outlet, wherein the inlet is in fluid communication with the second portion of the fuel fitting to receive fuel from the auxiliary tank and the outlet is in fluid communication with the first fuel tank to deliver fuel from the pump to the first fuel tank.

8. The fuel storage system of claim 1 wherein the fuel fitting is a quick-release fitting.

9. The fuel storage system of claim 8 wherein:
the first portion of the fuel fitting includes a first spring biasing a piston in the first portion of the fuel fitting to a closed position,
the second portion of the fuel fitting includes a second spring biasing a plunger in the second portion of the fuel fitting to a closed position, and
when the fuel-powered machine is placed on the auxiliary fuel tank, the plunger engages the piston and a weight of the fuel-powered machine causes each of the first spring and the second spring to become compressed such that the both the piston and the plunger are moved to an open position establishing, at least in part, the fluid flow path between the auxiliary tank and the first fuel tank.

10. A modular fuel storage system for an engine, the modular fuel storage system comprising:
a main fuel tank including:
a first cavity operable to contain fuel,
a first fill opening in fluid communication with the first cavity,
a fill cap removably mounted to the first fill opening,
a first passage establishing a fluid flow path between the first cavity and the engine,
a second passage in fluid communication with ambient air, and
a first portion of a quick-release fuel fitting in fluid communication with the first cavity; and
an auxiliary fuel tank removably mounted to the main fuel tank, the auxiliary fuel tank including:
a second cavity operable to contain fuel,
a second fill opening in fluid communication with the second cavity,
a fill cap removably mounted to the second fill opening,
a second portion of the quick-release fuel fitting, wherein when the auxiliary fuel tank is mounted to the main fuel tank, the first and second portions of the quick-release fuel fittings establish a fuel flow path between the auxiliary fuel tank and the main fuel tank.

11. The modular fuel storage system of claim 10 wherein:
the first portion of the quick-release fuel fitting is located remotely from the first cavity,
the first portion of the quick-release fuel fitting includes a first hose fitting and a second hose fitting,
the first hose fitting receives a fuel line connected between the first cavity and the first hose fitting,
the second hose fitting is in fluid communication with ambient air,
the first portion of the quick-release fuel fitting establishes a fluid flow path between the first hose fitting and the second hose fitting to ambient air when the auxiliary fuel tank is not mounted to the main fuel tank, and
the first portion of the quick-release fuel fitting establishes a fluid flow path between the first hose fitting and the second portion of the quick-release fuel fitting when the auxiliary fuel tank is mounted to the main fuel tank.

12. The modular fuel storage system of claim 10 wherein:
the main fuel tank further includes a first portion of an electrical connector,
the auxiliary fuel tank further includes a second portion of the electrical connector, and
the auxiliary fuel tank includes at least one sensor operable to transmit a signal via the electrical connector when the auxiliary fuel tank is mounted to the main fuel tank.

13. The modular fuel storage system of claim 10 wherein:
the main fuel tank and the engine are mounted to a housing having a plurality of feet, and
the auxiliary fuel tank includes a housing having a plurality of cavities on an upper surface of the housing, each cavity operable to receive one of the plurality feet when the auxiliary tank is mounted to the main fuel tank.

14. The modular fuel storage system of claim 10 further comprising:
a fuel pump having an inlet and an outlet;
a first fuel line connected between the first portion of the quick-release fuel fitting and the inlet of the fuel pump; and
a second fuel line connected between the outlet and the first cavity.

15. The fuel storage system of claim 10 wherein:
the first portion of the fuel fitting includes a first spring biasing a piston in the first portion of the fuel fitting to a closed position,
the second portion of the fuel fitting includes a second spring biasing a plunger in the second portion of the fuel fitting to a closed position, and
when the engine and the main fuel tank are placed on the auxiliary fuel tank, the plunger engages the piston and a weight of the engine and the main fuel tank causes each of the first spring and the second spring to become compressed such that the both the piston and the plunger are moved to an open position establishing, at least in part, the fuel flow path between the auxiliary tank and the first fuel tank.

16. An auxiliary fuel tank for use in a fuel storage system, the auxiliary fuel tank comprising:
a housing having an upper surface and a lower surface opposite the upper surface, wherein the upper surface includes a plurality of cavities and each of the plurality of cavities is configured to receive a foot from a fuel-powered machine placed on the upper surface;
a first portion of a fuel fitting mounted in the upper surface of the housing, wherein the first portion of the fuel fitting is operable to engage a second portion of the fuel fitting mounted in a lower surface of the fuel-powered machine placed on the upper surface;
a cavity within the housing operable to receive fuel via a fill opening; and
a vent operative to selectively establish an air flow path between ambient air and the cavity, wherein when the fuel-powered machine is placed on the upper surface of the auxiliary fuel tank, the first portion of the fuel fitting operatively engages the second portion of the fuel fitting to establish a fluid flow path between the auxiliary tank and the fuel-powered machine.

17. The auxiliary fuel tank of claim 16 further comprising a fuel cap removably mounted to the fill opening, wherein the fuel cap includes the vent operative to selectively establish the air flow path between ambient air and the cavity.

18. The auxiliary fuel tank of claim 16 further comprising a first portion of an electrical connector mounted in the upper surface of the housing, wherein the first portion of the electrical connector is operable to engage a second portion of the electrical connector mounted in the lower surface of the fuel-powered machine placed on the upper surface.

19. The auxiliary fuel tank of claim 16 wherein the fuel fitting is a quick-release fitting.

20. The auxiliary fuel tank of claim 19 wherein:
the first portion of the fuel fitting includes a first spring biasing a plunger in the first portion of the fuel fitting to a closed position,
the second portion of the fuel fitting includes a second spring biasing a piston in the second portion of the fuel fitting to a closed position, and
when the fuel-powered machine is placed on the auxiliary fuel tank, the plunger engages the piston and a weight of the fuel-powered machine causes each of the first spring and the second spring to become compressed such that the both the plunger and the piston are moved to an open position establishing, at least in part, the fluid flow path between the auxiliary tank and the fuel-powered machine.
